(19) United States
(12) Patent Application Publication
(10) Pub. No.: US 2007/0074099 A1
(43) Pub. Date: Mar. 29, 2007

(54) Computer-implemented method, system, and program product for advising a client

(75) Inventors: Gregory A. Chouiniere, Jasper, GA (US); Brian L. Kramer, Marietta, GA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/238,705

(22) Filed: Sep. 29, 2005

(51) Int. Cl. G06F 17/00

(52) U.S. Cl. 715/503

(57) ABSTRACT

Under the present invention, as an interviewer conducts interviews with interviewees, the interviewer will record the interview details (e.g., questions, interviewee comments, etc.) in one or more word processing documents. Thereafter, the comments (and optionally the questions) will be populated into a first column of spreadsheet pages, with each interview being represented in a separate spreadsheet page. Issue areas related to client issues will also be identified and populated into headers of subsequent columns of each of the spreadsheet pages. Thereafter, categorization indicators will be populated into the subsequent columns based on the categorization of the comments. Using the indicators, totals for the issue areas across the spreadsheet pages can be determined, and a resulting distribution of the comments can be analyzed to determine a course of action for the client.

### FIELD OF THE INVENTION

The present invention generally relates to client interview data analysis and management. Specifically, the present invention relates to a computer-implemented method, system, and program product for advising a client

### BACKGROUND OF THE INVENTION

Oftentimes, consultants are asked to survey a large number of people in order to gather the facts needed to support a new business direction. Due to the large volume of data that can be gathered, credibly and cost effectively completing this task can be a challenge. Currently, most consultants record each interview in some type of document, and then manually look through each interview for common themes and root cause information. The lack of a simple, automated method makes this process increasingly cumbersome and less credible as the volume of data grows. This becomes an even bigger issue when clients begin challenging conclusions that are based on the interview data. Pulling together supporting information may be too complex a task, and therefore puts the credibility of the consulting work at risk. As such, not only is data management an issue with existing approaches, but providing credible advice to clients is as well.

In view of the foregoing, there exists a need to overcome the aforementioned deficiencies in the existing art.

### SUMMARY OF THE INVENTION

In general, the present invention provides a computer-implemented method, system, and program product for advising a client. Specifically, under the present invention, as an interviewer conducts interviews with interviewees, the interviewer will record the interview details (e.g., questions, interviewee comments, etc.) in one or more word processing documents. Thereafter, the comments (and optionally the questions) will be populated into a first column of spreadsheet pages, with each interview being represented in a separate spreadsheet page. For example, the comments from interviewee “A” will appear in spreadsheet page “A”, while the comments from interviewee “B” will appear in spreadsheet page “B”. In addition, issue areas related to client issues will be identified and populated into headers of subsequent columns of each of the spreadsheet pages. This allows the comments to be categorized into one or more of these areas. Thereafter, categorization indicators will be populated into these subsequent columns based on the categorization of the comments. Using the indicators, totals for the issue areas across the spreadsheet pages can be determined, and a resulting distribution of the comments can be analyzed to determine a course of action for the client.

A first aspect of the present invention provides a computer-implemented method for advising a client, comprising: receiving comments related to a plurality of client interviews; providing a plurality of issue areas related to client issues; categorizing each of the comments into one or more of the plurality of issue areas within a plurality of spreadsheet pages, wherein each of the plurality of client interviews is represented in a separate spreadsheet page; and analyzing a distribution of the comments among the plurality of issue areas across the plurality of spreadsheet pages to determine a course of action for the client.

A second aspect of the present invention provides a computer-implemented method for advising a client, comprising: providing comments related to a plurality of client interviews in a word processing document; populating the comments for the plurality of interviews into a first column of a plurality of spreadsheet pages, wherein each of the plurality of interviews is represented in a separate spreadsheet page; providing a plurality of issue areas related to client issues in subsequent columns of the plurality of spreadsheet pages; categorizing each of the plurality of comments into one or more of the plurality of issue areas related to client issues; and analyzing a distribution of the comments among the plurality of issue areas across the plurality of spreadsheet pages to determine a course of action for the client.

A third aspect of the present invention provides a computer-implemented system for advising a client, comprising: a comment system for populating comments for a plurality of interviews from a word processing document into a first column of a plurality of spreadsheet pages, wherein each of the plurality of interviews is represented in a separate spreadsheet page; an indicator system for populating categorization indicators for the comments into subsequent columns of the spreadsheet pages, wherein the categorization indicators pertain to issue areas related to client issues; and a distribution system for analyzing a distribution of the comments among the plurality of issue areas across the plurality of spreadsheet pages to determine a course of action for the client.

A fourth aspect of the present invention provides a program product stored on a computer useable medium for advising a client, the computer useable medium comprising program code for causing a computer system to perform the following steps: populating comments for a plurality of interviews from a word processing document into a first column of a plurality of spreadsheet pages, wherein each of the plurality of interviews is represented in a separate spreadsheet page; populating categorizing indicators for the comments into subsequent columns of the spreadsheet pages, wherein the categorization indicators pertain to issue areas related to client issues; and analyzing a distribution of the comments among the plurality of issue areas across the plurality of spreadsheet pages to determine a course of action for the client.

A fifth aspect of the present invention provides a method for deploying an application for advising a client, comprising: providing a computer infrastructure being operable to: populate comments for a plurality of interviews from a word processing document into a first column of a plurality of spreadsheet pages, wherein each of the plurality of interviews is represented in a separate spreadsheet page; populate categorizing indicators for the comments into subsequent columns of the spreadsheet pages, wherein the categorization indicators pertain to issue areas related to client issues; and analyze a distribution of the comments among the plurality of issue areas across the plurality of spreadsheet pages to determine a course of action for the client.

A sixth aspect of the present invention provides computer software embodied in a propagated signal for advising a client, the computer software comprising instructions for causing a computer system to perform the following steps: populating comments for a plurality of interviews from a word processing document into a first column of a plurality of spreadsheet pages, wherein each of the plurality of interviews is represented in a separate spreadsheet page; populating categorizing indicators for the comments into subsequent columns of the spreadsheet pages, wherein the categorization indicators pertain to issue areas related to client issues; and analyzing a distribution of the comments among the plurality of issue areas across the plurality of spreadsheet pages to determine a course of action for the client.

Therefore, the present invention provides a computer-implemented method, system and program product for advising a client.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a spreadsheet page as populated according to the present invention.

FIG. 2 depicts an illustrartive chart of issue areas according to the present invention.

FIG. 3 depicts illustrative totals of comments as categorized into the issue areas of FIG. 2.

FIG. 4 depicts an illustrative distribution of comments among the issue areas of FIG. 2.

FIG. 5 depicts an illustrative graphical representation of FIG. 4.

FIG. 6 depicts an alternate graphical representation of FIG. 4.

FIG. 7 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

For convenience purposes, the Best Mode for Carrying Out the Invention will have the following sub-sections:

I. General Description

II. Illustrative Embodiment

III. Computerized Implementation

I. General Description

As indicated above, the present invention provides a computer-implemented method, system, and program product for advising a client. Specifically, under the present invention, as an interviewer conducts interviews with interviewees, the interviewer will record the interview details (e.g., questions, interviewee comments, etc.) in one or more word processing documents. Thereafter, the comments (and optionally the questions) will be populated into a first column of spreadsheet pages, with each interview being represented in a separate spreadsheet page. For example, the comments from interviewee “A” will appear in spreadsheet page “A”, while the comments from interviewee “B” will appear in spreadsheet page “B”. In addition, issue areas related to client issues will be identified and populated into headers of subsequent columns of each of the spreadsheet pages. This allows the comments to be categorized into one or more of these areas. Thereafter, categorization indicators will be populated into these subsequent columns based on the categorization of the comments. Using the indicators, totals for the issue areas across the spreadsheet pages can be determined, and a resulting distribution of the comments can be analyzed to determine a course of action for the client.

II. Illustrative Embodiment

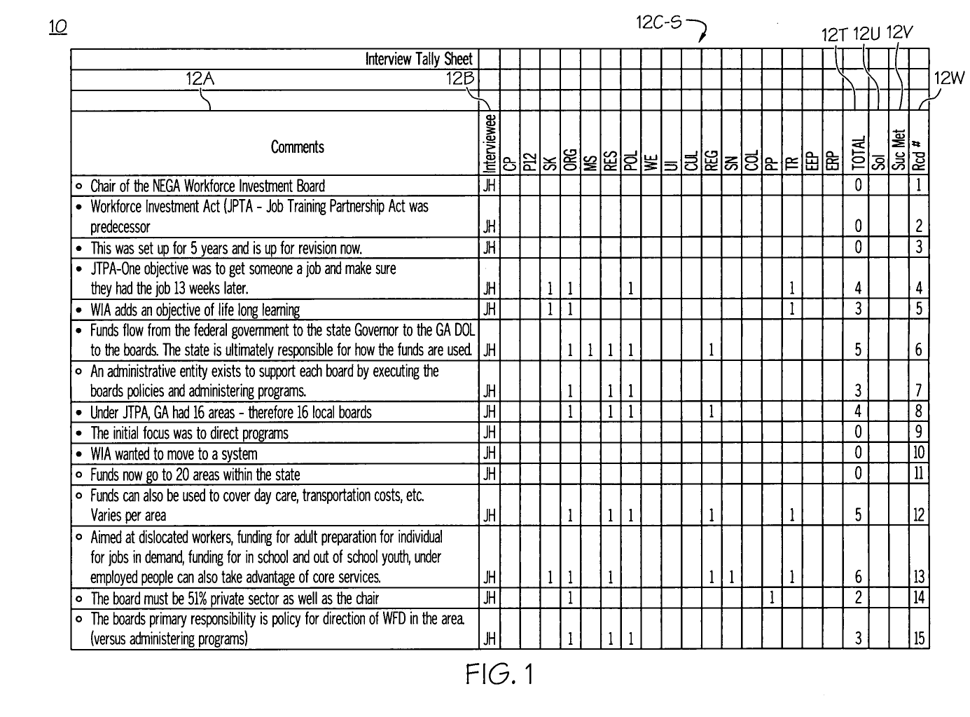

A typical embodiment of the present invention will now be described in conjunction with FIGS. 1-6. In general, the present invention allows data from a series of interviews to be collated and managed using a single tool. Specifically, in this illustrative embodiment, assume that a service provider (e.g., a consultant) is conducting interviews on behalf of a client, and providing advice based thereon. To commence the process, the first steps are to identify who should be interviewed and what questions need to be asked. Once the questions are determined, they will be input into a word processing document or the like, the interview process will begin, and comments (e.g., responses to the questions) from the interviewees will be input into the word processing document.

After a number of interviews are conducted, analysis of the data will begin. Under the present invention, this will involve utilizing a spreadsheet page for each interview. Specifically, interview details/data such as the questions asked and the resulting interviewee comments from each interview will be populated (e.g., copy and pasted) from the word processing document into a first column of a spreadsheet page. In so doing, each interview will be represented in a separate interview page. For example, comments from interviewee “A” will be populated into spreadsheet page “A”, comments from interviewee “B” will be populated into spreadsheet page “B”, and so on. Thus, if there were forty-five interviews conducted, there will be 45 spreadsheet pages. Moreover, all of the spreadsheet pages will typically be maintained in a common “workbook” for easier analysis as will be further described below.

Referring to FIG. 1, an illustrative spreadsheet page 10 as populated according to the present invention is shown in greater detail. As can be seen, spreadsheet page 10 includes a series of columns and rows. Column 12A is where interview details such as interviewer questions and interview comments are populated. Column 12B is where the interviewee's initials are populated. Columns 12C-S are where categorization indicators for issue areas related to client issues are populated. Specifically, when interviewing each interviewee, certain themes or issues areas become apparent. As an issue area becomes apparent, it will be assigned a column in spreadsheet page 10. If a comment populated into column 12A touches upon a particular issue area, a categorization indicator (e.g., the number one) will be placed in the column for that issue area. For example, in column 12A, the comment “WIA adds an objective of life long learning” touched upon the issue areas “SK”, “ORG”, and “TR”.

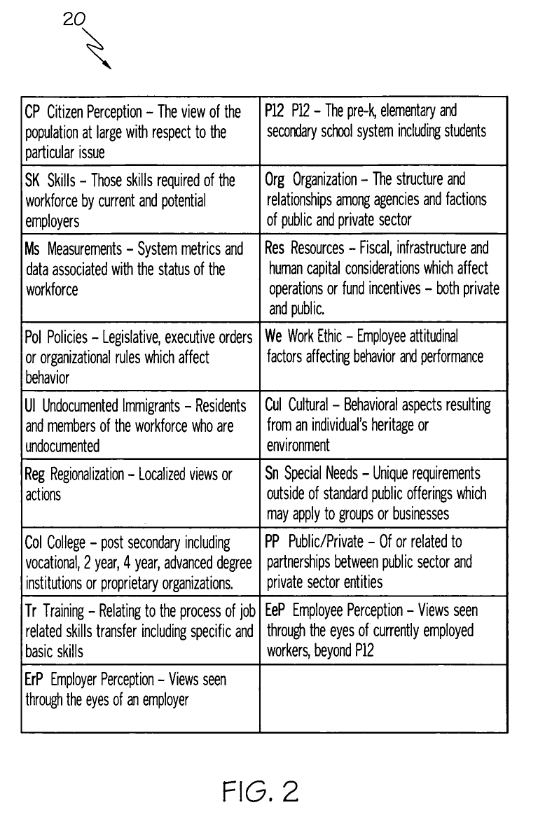

Under the present invention, there can be any number of issue areas, and those shown herein are only intended to be illustrative. However, referring to FIG. 2, a chart 20 explaining the issue areas presented in FIG. 1 is shown. As shown, the following issue areas are represented in this illustrative embodiment:

CP: Citizen Perception —The view of the population at large with respect to the particular issue.

P12: P12—The pre-k, elementary and secondary school system including students.

SK: Skills —Those skills required of the workforce by current and potential employers.

Org: Organization —The structure and relationships among agencies and factions of public and private sector.

Ms: Measurements —System metrics and data associated with the status of the workforce.

Res: Resources —Fiscal, infrastructure and human capital considerations which affect operations or fund incentives —both private and public.

Pol: Policies —Legislative, executive orders or organizational rules which affect behavior.

We: Work Ethic —Employee attitudinal factors affecting behavior and performance.

UI: Undocumented Immigrants —Residents and members of the workforce who are undocumented.

Cul: Cultural —Behavioral aspects resulting from an individual's heritage or environment.

Reg: Regionalization —Localized views or actions.

Sn: Special Needs —Unique requirements outside of standard public offerings which may apply to groups or businesses.

Col: College —post secondary including vocational, 2 year, 4 year, advanced degree institutions or proprietary organizations.

PP: Public/Private —Of or related to partnerships between public sector and private sector entities.

Tr: Training —Relating to the process of job related skills transfer including specific and basic skills.

EeP: Employee Perception —Views seen through the eyes of currently employed workers, beyond P12.

ErP: Employer Perception —Views seen through the eyes of an employer. Referring back to FIG. 1, it can be seen that each of the issue areas (or identifiers therefor) are populated into headers for columns 12C-S, which are subsequent to columns 12A-B in spreadsheet page 10. This allows categorization indicators to be populated in columns 12C-S as necessary. By so doing, the comments for each interview are categorized into one or more of the issue areas. This will be used, as further explained below, for determining courses of actions and presenting advice to the client for whom the interviews are being conducted.

In any event, spreadsheet page 10 also shows columns 12T, 12U, 12V, and 12W. Column 12T can be used to provide a row-based total of categorization indicators for each comment. Column 12U can be used to hold an indicator when one of the comments represents a possible solution to the problem for which advice is being requested by the client. Column 12V can be used to hold an indicator when one of the comments represents a possible success metric. Lastly, column 12W can be used to hold an indicator representing the quantity of the comments. For example, the comment “WIA adds an objective of life long learning” represents the fourth comment received from interviewee “JH”.

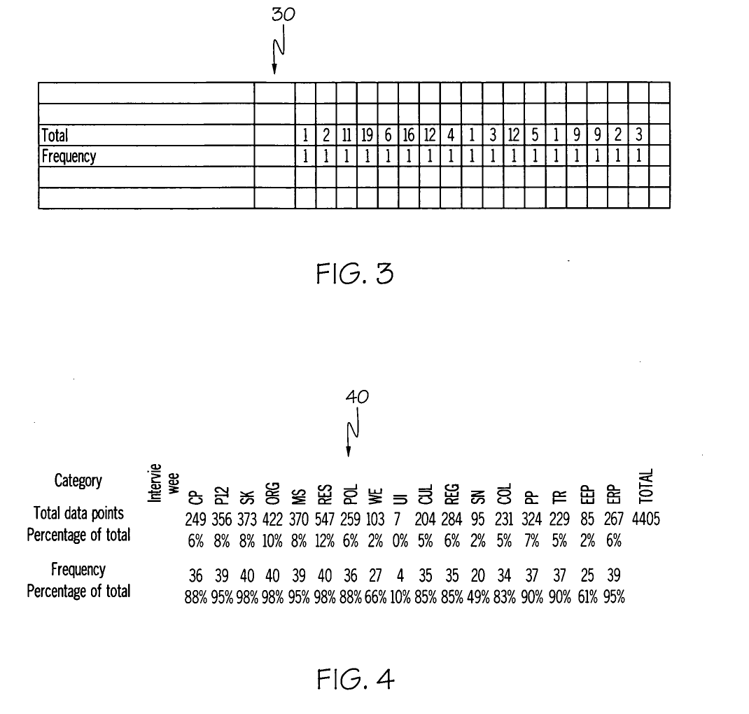

At a line/row in spreadsheet page 10 that is below the comments (e.g., approximately line 100 in this illustrative example), a “total” line should be created. This is determined by the greatest number of interview comments the interviewers expect might occur. In a typical embodiment, the same line is used across all interview sheets since it will make the analysis on the totals easier. Referring to FIG. 3, a segment 30 of spreadsheet page 10 of FIG. 1 showing such illustrative totals and frequency of comments among the issue areas is shown.

When all interviews are in this format, a consolidation of all data can be performed. This will represent a compilation of all the data points. The first part of the analysis will yield a frequency distribution, indicating a relative weight of issues against the issue areas. That is, a distribution of the comments among the issue areas across the spreadsheet pages will be determined and analyzed to determine a course of action for the client. Based thereon, advice can be provided. FIG. 4 illustrates how the data can be tabulated and represented within a spreadsheet. Specifically, FIG. 4 depicts a distribution 40 of the comments among the issue areas across all spreadsheet pages as determined under the present invention. For example, distribution 40 sets forth total data points, percentage of the total data points that each individual data point total represents, a frequency value, and a percentage of the total frequency that each individual frequency value represents.

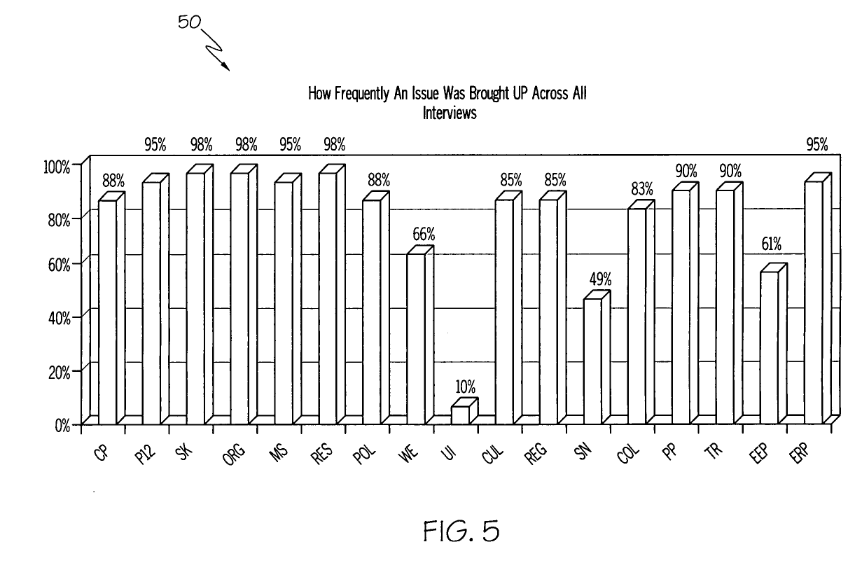

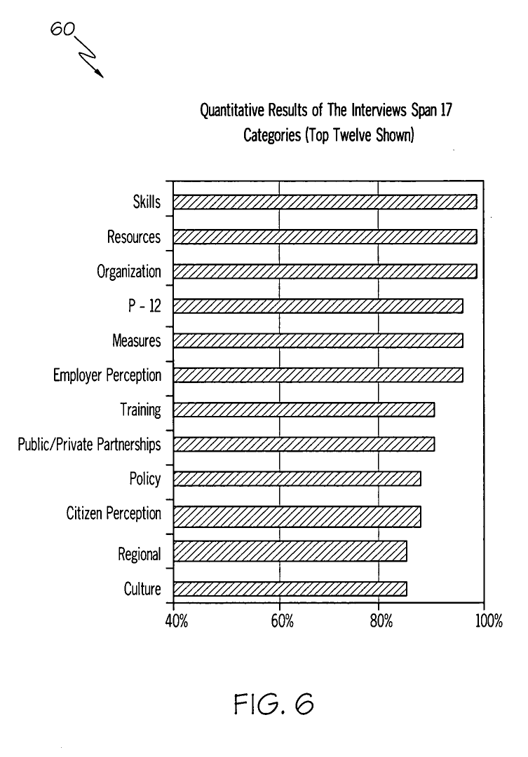

FIG. 5 illustrates how this data can be represented graphically. Specifically, FIG. 5 depicts a graph 50 of how frequently an issue area was brought up across all interviews. For example, the issue area “CP” was touched upon in 88% of the interviews, while the issue area “UI” was touched upon in only 10% of the interviews. FIG. 6 shows an alternative graphical representation 60 of FIG. 5. Regardless of the precise representation, the distribution shown in FIGS. 4-6 can be use to provide advice to the client, such as which issue areas were deemed most important.

In completing this process, each interview can be populated into a single spreadsheet page. This will allow for the efficient sorting of data by issue, success metric or solution. Using the record numbers that were manually keyed in for each interview statement, combined with the interviewee's initials, it's possible to determine the source of each statement.

III. Computerized Implementation

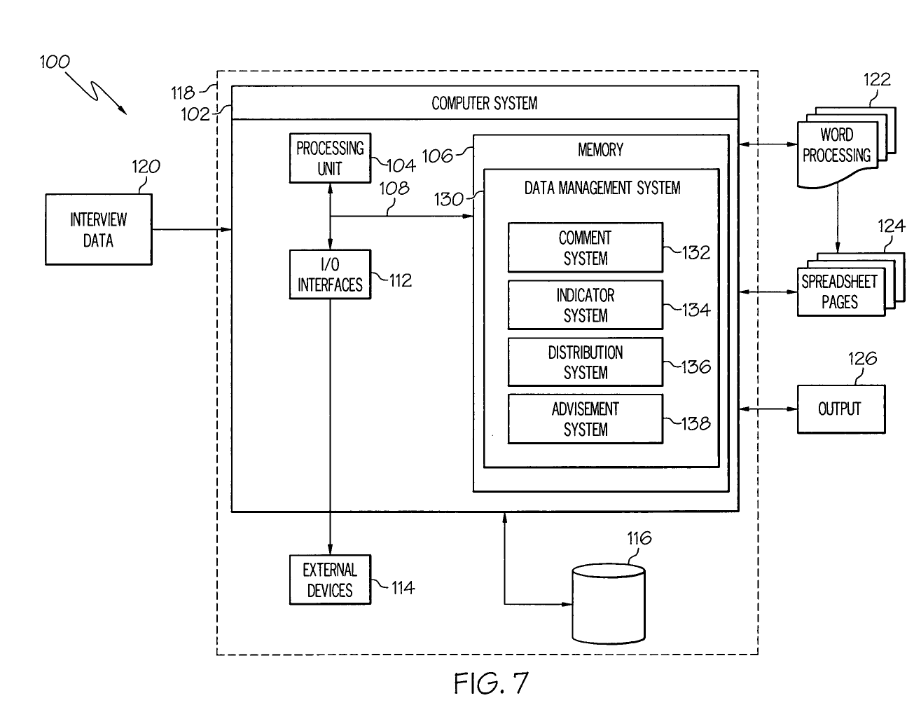

Referring now to FIG. 7, a more detailed computerized implementation 100 of the present invention is shown. As depicted, implementation 100 includes a computer system 102 deployed within a computer infrastructure 118. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 118 is intended to demonstrate that some or all of the components of implementation 100 could be deployed, managed, serviced, etc. by a service provider who offers to conduct interviews and/or advise a client.

As further shown, computer system 102 includes a processing unit 104, a memory 106, a bus 108, and input/output (I/O) interfaces 112. Further, computer system 102 is shown in communication with external I/O devices/resources 114 and storage system 116. In general, processing unit 104 executes computer program code, such as data management system 130, which is stored in memory 106 and/or storage system 116. While executing computer program code, processing unit 104 can read and/or write data to/from memory 106, storage system 116, and/or I/O interfaces 112. Bus 108 provides a communication link between each of the components in computer system 102. External devices 114 can comprise any devices (e.g., keyboard, pointing device, display, etc.) that enable a user to interact with computer system 102 and/or any devices (e.g., network card, modem, etc.) that enable computer system 102 to communicate with one or more other computing devices.

Computer system 102 is only representative of various possible computer systems that can include numerous combinations of hardware and/or software. To this extent, in other embodiments, computer system 102 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 104 may comprise a single processing unit, or be distributed across one or more processing units in one or more locations, e.g., on a client and server. Similarly, memory 106 and/or storage system 116 can comprise any combination of various types of data storage and/or transmission media that reside at one or more physical locations. Further, I/O interfaces 112 can comprise any system for exchanging information with one or more external devices 114. Still further, it is understood that one or more additional components (e.g., system software, math co-processing unit, etc.) not shown in FIG. 7 can be included in computer system 102. However, if computer system 102 comprises a handheld device or the like, it is understood that one or more external devices 114 (e.g., a display) and/or storage system(s) 116 could be contained within computer system 102, not externally as shown.

Storage system 116 can be any type of system (e.g., a database) capable of providing storage for information under the present invention, including, for example, interview data 120, word processing documents 122, spreadsheet pages 124, numerical tabulations/distributions, client advice, etc. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). Although not shown, additional components, such as cache memory, communication systems, system software, etc., may be incorporated into computer system 102.

Shown in memory 106 of computer system 102 is data management system 130, which is a software program that will provide the functions of the present invention, and which includes a comment system 132, an indicator system 134, a distribution system 136, and an advisement system 138. These systems provide the functionality of the present invention as discussed above. Specifically, assume that interviews have been conducted, and interview data 120 has been collected. Such data can include, among other things, the questions asked, the comments made in response, etc. As indicated above, such data is initially provided in one or more word processing documents 122 or the like. Regardless, comment system 132 will populate the comments from interview data 120 (and optionally the questions as well) into a first column of the spreadsheet pages 124, with each interview being represented in a separate spreadsheet page 124 of a workbook. It should be understood that the spreadsheet pages could be created initially by comments system 132 from a template or the like that is stored in storage system 116.

In any event, once the comments are populated, indicator system 134 can populate categorization indicators for the issue areas into subsequent columns of the spreadsheet pages. Such population could be based upon manual prompts by an interviewer, or indicator system 134 could be programmed to analyze each comment and automatically place an indicator where appropriate. Once all interviews have been populated and categorized into the issue areas, distribution system 136 will determine the distribution of the comments among the issue areas across spreadsheet pages 124. Distribution system 136 can then generate any needed or requested graphical representations of the distribution for analysis and/or presentation purposes. Based on the distribution, advisement system 138 can provide output 126 in the form of advice, graphical representations, etc. In providing advice, advisement system 138 could be programmed to accept input from an interviewer, and/or it could be programmed to analyze the distribution and automatically provide advice based on rules, templates, etc.

While shown and described herein as a method, system and program product for providing advice to a client, it is understood that the invention further provides various alternative embodiments. For example, in one embodiment, the invention provides a computer-readable/useable medium that includes computer program code to enable a computer infrastructure perform the functions of the present invention. To this extent, the computer-readable/useable medium includes program code that implements each of the various process steps of the invention. It is understood that the terms computer-readable medium or computer useable medium can comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 106 (FIG. 7) and/or storage system 116 (FIG. 7) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to provide advice to a client. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing advice to a client. In this case, a computer infrastructure can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 102 (FIG. 7), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for advising a client, comprising:
receiving comments related to a plurality of client interviews;
providing a plurality of issue areas related to client issues;
categorizing each of the comments into one or more of the plurality of issue areas within a plurality of spreadsheet pages, wherein each of the plurality of client interviews is represented in a separate spreadsheet page; and
analyzing a distribution of the comments among the plurality of issue areas across the plurality of spreadsheet pages to determine a course of action for the client.

2. The computer-implemented method of claim 1, further comprising advising the client based on the course of action.

3. The computer-implemented method of claim 1, further comprising:
populating the comments into a first column of the plurality of spreadsheet pages; and
populating the plurality of issue areas into headers of subsequent columns of the plurality of spreadsheet pages.

4. The computer-implemented method of claim 1, further comprising determining comment totals for each of the plurality of issue areas across the plurality of client interviews.

5. The computer-implemented method of claim 1, wherein the plurality of issue areas are derived from the plurality of client interviews.

6. The computer-implemented method of claim 1, wherein the receiving step comprises receiving the plurality of comments in a word processing document.

7. A computer-implemented method for advising a client, comprising:
providing comments related to a plurality of client interviews in a word processing document;
populating the comments for the plurality of interviews into a first column of a plurality of spreadsheet pages, wherein each of the plurality of interviews is represented in a separate spreadsheet page;
providing a plurality of issue areas related to client issues in subsequent columns of the plurality of spreadsheet pages;
categorizing each of the plurality of comments into one or more of the plurality of issue areas related to client issues; and
analyzing a distribution of the comments among the plurality of issue areas across the plurality of spreadsheet pages to determine a course of action for the client.

8. The computer-implemented method of claim 7, further comprising advising the client based on the course of action.

9. The computer-implemented method of claim 7, further comprising populating the plurality of issue areas into headers of subsequent columns of the plurality of spreadsheet pages.

10. The computer-implemented method of claim 7, wherein the plurality of issue areas are derived from the plurality of client interviews.

11. A computer-implemented system for advising a client, comprising:
a comment system for populating comments for a plurality of interviews from a word processing document into a first column of a plurality of spreadsheet pages, wherein each of the plurality of interviews is represented in a separate spreadsheet page;
an indicator system for populating categorization indicators for the comments into subsequent columns of the spreadsheet pages, wherein the categorization indicators pertain to issue areas related to client issues; and
a distribution system for analyzing a distribution of the comments among the plurality of issue areas across the plurality of spreadsheet pages to determine a course of action for the client.

12. The computer implemented system of claim 11, wherein the indicator system electronically receives the categorization indicators and populates the categorization indicators into the subsequent columns.

13. The computer implemented system of claim 11, wherein the indicator system further populates the plurality of issue areas into headers of the subsequent columns.

14. The computer implemented system of claim 11, wherein the distribution system determines totals of the categorization indicators for each of the plurality of issue areas across the plurality of spreadsheet pages.

15. The computer implemented system of claim 11, further comprising an advisement system for determining the course of action, and for outputting advice for the client based on the course of action.

16. A program product stored on a computer useable medium for advising a client, the computer useable medium comprising program code for causing a computer system to perform the following steps:
populating comments for a plurality of interviews from a word processing document into a first column of a plurality of spreadsheet pages, wherein each of the plurality of interviews is represented in a separate spreadsheet page;
populating categorizing indicators for the comments into subsequent columns of the spreadsheet pages, wherein the categorization indicators pertain to issue areas related to client issues; and
analyzing a distribution of the comments among the plurality of issue areas across the plurality of spreadsheet pages to determine a course of action for the client.

17. The program product of claim 16, wherein the step of populating the categorization indicators comprises electronically receiving the categorization indicators and populating the categorization indicators into the subsequent columns.

18. The program product of claim 16, wherein the program code further causes the computer system to perform the following step: populating the plurality of issue areas into headers of the subsequent columns.

19. The program product of claim 16, wherein the program code further causes the computer system to perform the following step: determining totals of the categorization indicators for each of the plurality of issue areas across the plurality of spreadsheet pages.

20. The program product of claim 16, wherein the program code further causes the computer system to perform the following steps:
determining the course of action; and
outputting advice for the client based on the course of action.

21. A method for deploying an application for advising a client, comprising:
providing a computer infrastructure being operable to:
populate comments for a plurality of interviews from a word processing document into a first column of a plurality of spreadsheet pages, wherein each of the plurality of interviews is represented in a separate spreadsheet page;
populate categorizing indicators for the comments into subsequent columns of the spreadsheet pages, wherein the categorization indicators pertain to issue areas related to client issues; and
analyze a distribution of the comments among the plurality of issue areas across the plurality of spreadsheet pages to determine a course of action for the client.

22. The method of claim 21, wherein the computer infrastructure is further operable to:
populate the plurality of issue areas into headers of the subsequent columns;
determine totals of the categorization indicators for each of the plurality of issue areas across the plurality of spreadsheet pages;
determine the course of action; and
output advice for the client based on the course of action.
